(19) United States
(12) Patent Application Publication
(10) Pub. No.: US 2008/0131724 A1
(43) Pub. Date: Jun. 5, 2008

(54) CERAMIC ARMOR, METHODS OF JOINING A CARBIDE WITH A METAL-COMPRISING PIECE, AND METHODS OF METALLIZING CARBIDE-COMPRISING SURFACES

(76) Inventors: Henry Shiu-Hung Chu, Idaho Falls, ID (US); Paul Alan Chu, Idaho Falls, ID (US); Thomas Martin Lillo, Idaho Falls, ID (US); Arnold Wendell Erickson, Idaho Falls, ID (US)

Correspondence Address: BATTELLE ENERGY ALLIANCE, LLC, P.O. BOX 1625, IDAHO FALLS, ID, 83415-3899, US

(21) Appl. No.: 11/567,075

(22) Filed: Dec. 5, 2006

(51) Int. Cl. B32B 15/04; B23K 31/02

(52) U.S. Cl. 428/627; 228/122.1

(57) ABSTRACT

The invention includes pieces of ceramic armor, methods of joining a carbide with a metal-comprising piece, and methods of metallizing carbide-comprising surfaces. In one implementation, a method of joining a carbide with a metal-comprising piece includes providing a mixture comprising (a) and (b) over a carbide-comprising surface of a substrate, where (a) comprises at least one of niobium and titanium, and (b) comprises silicon. The mixture is heated over the carbide-comprising surface at least to the melting temperatures (a) and (b). The melted mixture is solidified into an adherent layer on the substrate. A metal-based joining material is provided over the adherent layer. Metal of a metal-comprising piece is welded to the substrate with the metal-based joining material.

### GOVERNMENT RIGHTS

The United States Government has certain rights in this invention pursuant to Contract No. DE-AC07-051D14517 between the United States Department of Energy and Battelle Energy Alliance, LLC.

### TECHNICAL FIELD

This invention relates to pieces of ceramic armor, to methods of joining a carbide with a metal-comprising piece, and methods of metallizing carbide-comprising surfaces.

### BACKGROUND OF THE INVENTION

It is often desirable to join ceramic materials, such as carbides, with a piece of metal. One particular application, for example, is to form a piece of armor made of a sheet of metal carbide bonded to a sheet of metal, for example a titanium alloy, thus forming a piece of ceramic armor. For example and by way of example only, 8″×10″ or smaller pieces of such material might be created and then inserted into a jacket that a person might wear, with the armor blocking or shielding the person from projectile impacts to the body.

Existing methods of joining a ceramic such as a metal carbide with a piece of metal conventionally utilize glue-like adhesives which are typically primarily organic. Unfortunately, the bonding strength attained with such adhesives is not as high as desirable, and can result in delamination. Welding has also been attempted for directly adhering metal carbides to metal layers. However, the welding filler material is typically unsuccessful in achieving a good bond between the metal and ceramic.

While the invention was motivated in addressing the above identified issues, it is in no way so limited. The invention is only limited by the accompanying claims as literally worded, without interpretative or other limiting reference to the specification, and in accordance with the doctrine of equivalents.

### SUMMARY OF THE INVENTION

The invention includes pieces of ceramic armor, methods of joining a carbide with a metal-comprising piece, and methods of metallizing carbide-comprising surfaces. In one implementation, a method of joining a carbide with a metal-comprising piece includes providing a mixture comprising (a) and (b) over a carbide-comprising surface of a substrate, where (a) comprises at least one of niobium and titanium, and (b) comprises silicon. The mixture is heated over the carbide-comprising surface at least to the melting temperatures of (a) and (b). The melted mixture is solidified into an adherent layer on the substrate. A metal-based joining material is provided over the adherent layer. Metal of a metal-comprising piece is welded to the substrate with the metal-based joining material.

In one implementation, a method of metallizing a carbide-comprising surface includes providing a mixture comprising (a) and (b) over a carbide-comprising surface of a substrate, where (a) comprises at least one of niobium and titanium, and (b) comprises silicon. The mixture is heated over the carbide-comprising surface at least to the melting temperatures of (a) and (b). The melted mixture is solidified into an adherent layer on the carbide-comprising surface.

In one implementation, a piece of ceramic armor includes a sheet of metal. A metal-based layer of joining filler material is received on the sheet of metal. A layer comprising (a) and (b) is received over the metal-based joining filler material layer, where (a) comprises at least one of niobium and titanium, and (b) comprises silicon. A sheet of carbide-comprising material is received on the layer comprising (a) and (b).

Other aspects and implementations are contemplated.

### BRIEF DESCRIPTION OF THE DRAWINGS

Preferred embodiments of the invention are described below with reference to the following accompanying drawings.

FIG. 1 is a FIG. 1 is a diagrammatic cross section of a substrate fragment in process in accordance with an aspect of the invention.

FIG. 2 is a view of the FIG. 1 substrate at a processing step subsequent to that shown by FIG. 1.

FIG. 3 is a view of the FIG. 2 substrate at a processing step subsequent to that shown by FIG. 2.

FIG. 4 is a view of an alternate embodiment of the FIG. 2 substrate at a processing step subsequent to that shown by FIG. 2.

FIG. 5 is a view of the FIG. 3 substrate at a processing step subsequent to that shown by FIG. 3.

FIG. 6 is a view of the FIG. 5 substrate at a processing step subsequent to that shown by FIG. 5.

FIG. 7 is a view of the FIG. 4 substrate at a processing step subsequent to that shown by FIG. 4.

FIG. 8 is a view of an alternate embodiment substrate fragment.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

Aspects of the invention include methods of joining a carbide with a metal-comprising piece, methods of metallizing a carbide-comprising surface, and a piece of ceramic armor. Pieces of ceramic armor, as disclosed herein, are independent of the preferred embodiment methods of fabrication, as well as the methods disclosed and claimed herein being independent of fabrication of a piece of ceramic armor. Further, “ceramic armor” as used herein is not restricted to being comprised of 100% ceramic material(s), and as claimed includes metal in addition to ceramic material(s).

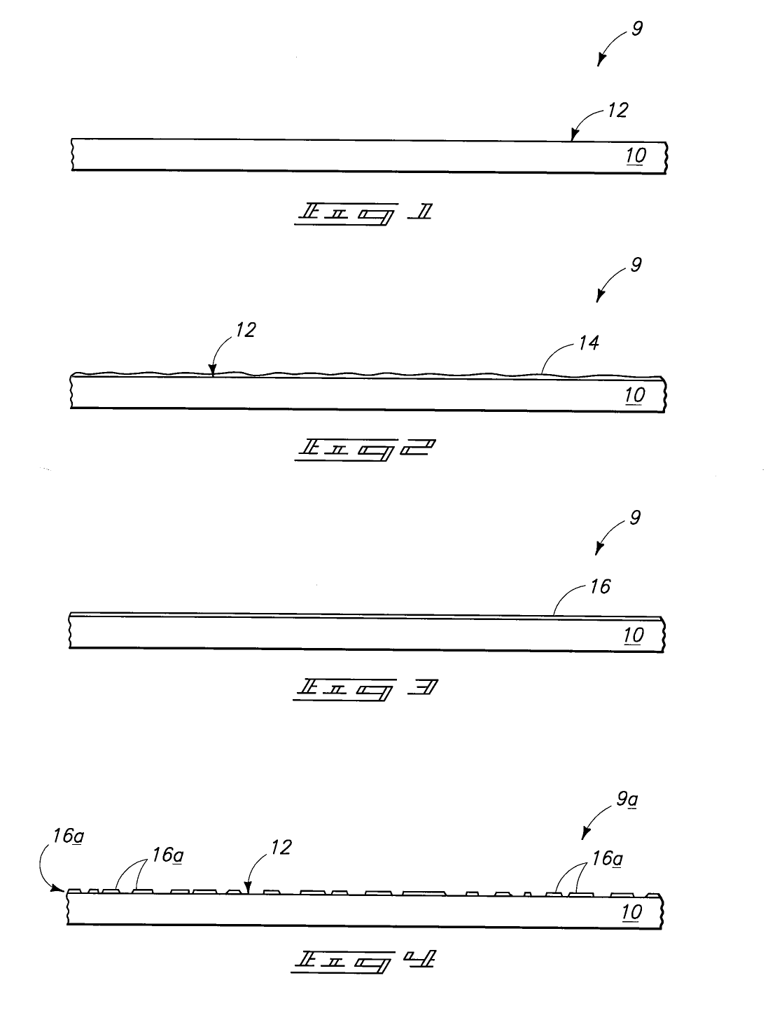

Referring to FIG. 1, a substrate fragment is indicated generally with reference numeral 9, and comprises a substrate 10. Such might be homogeneous, non-homogeneous, and/or comprise multiple different materials and/or layers of the same or different materials. In one implementation, such comprises a carbide-comprising surface 12, for example a metal carbide. By way of example only, example metal carbides include silicon carbide, boron carbide, titanium carbide and mixtures thereof. One example embodiment substrate 10 comprises a homogeneous sheet of a metal carbide, for example a sheet which is between ¼″ and 1″ thick.

Referring to FIG. 2, a mixture 14 comprising (a) and (b) has been provided over carbide-comprising surface 12 of substrate 10, where (a) comprises at least one of niobium and titanium, and (b) comprises silicon. Accordingly, component (a) might comprise either niobium or titanium alone, or both of niobium and titanium. Materials other than components (a) and (b) might also, of course, be provided in mixture 14. In one preferred embodiment, the weight ratio of a total of the at least one of niobium and titanium to silicon in the mixture is from 1:1 to 11:1, and even more preferably from 2.3:1 to 9:1. A specific preferred example is a weight ratio of 4:1.

In one embodiment, (a) comprises titanium, and the mixture comprises zirconium, titanium, copper and silicon. Preferably in such embodiment, a total of the zirconium, titanium, copper and silicon in the mixture is zirconium from 30-40 weight percent, silicon from 20-40 weight percent, titanium from 13-23 weight percent and copper from 7-13 weight percent. In one implementation, such mixture also comprises indium. In such instance, preferably a total of the zirconium, titanium, copper, indium and silicon in the mixture is zirconium from 30-40 weight percent, silicon from 20-40 weight percent, titanium from 13-23 weight percent, copper from 7-13 weight percent, and indium at no greater than 2 weight percent.

The (a) and (b) components, including other components, might be combined in powder or other form and mixed with an alcohol and/or water-based carrier to achieve a spreadable consistency. Alternately by way of example only, the desired mixture components might be mixed dry and applied directly onto surface 12, or as separate components and mixed over surface 12 (less preferred). A preferred example thickness range for mixture 14 in FIG. 2 is from 0.001 inch to 0.020 inch. FIG. 2 depicts one preferred embodiment wherein mixture 14 is provided on carbon-comprising surface 12, with “on” in the context of this document requiring at least some direct physical touching contact of the stated materials or surface. However, aspects of the invention also contemplate mixture 14 being provided over carbide-comprising surface 12 wherein one or more intervening materials or layers might be provided. Most preferred is mixture 14 being in at least some direct physical touching contact with carbide-comprising surface 12. If the mixture is provided with a liquid based carrier, such might be allowed to dry before subsequent processing, or subsequently processed without appreciable drying prior thereto.

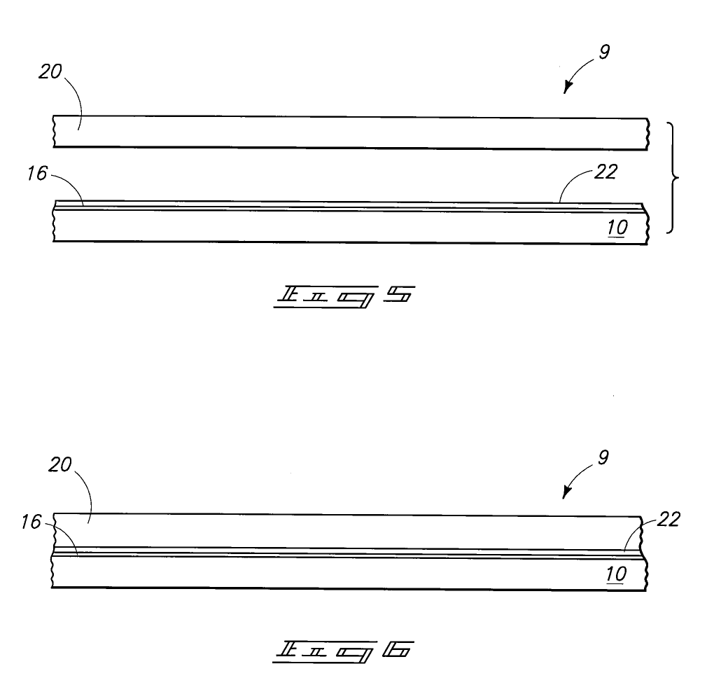

Referring to FIG. 3, mixture 14 of FIG. 2 has been heated over carbide-comprising surface 12 at least to the melting temperatures of (a) and (b). Preferably, the heating is to a temperature at least to the melting temperatures of all components in the mixture. An example preferred heating comprises raising the temperature of the substrate to from 1450° C. to 1550°. Such heating might occur within an atmospheric pressure, greater than atmospheric pressure, or sub-atmospheric pressure, atmosphere. In one preferred implementation, the atmosphere during the heating is at a pressure of no greater than 1 Torr, and even more preferably no greater than 1 mTorr. The atmosphere might be inert or non-inert, with the heating occurring within an atmosphere that is substantially void of O2 being preferred. In one implementation, the atmosphere predominately comprises a noble gas. In one preferred implementation, the atmosphere comprises H2 at no more than 4.0 percent atomic.

The melted mixture is solidified (i.e., by lowering the temperature) into an adherent layer 16 on the substrate. The thickness of adherent layer 16 might be reduced from that of layer 14 prior to the heating due to densification, and regardless some of adherent layer 16 might be polished or otherwise removed to change its outer surface characteristics and/or reduce its thickness. Further, if all of mixture 14 is not converted to an adherent layer 16, the remaining loosely or un-adhered material 14 might be removed from over adherent layer 16. Adherent layer 16 might be, and preferably is, continuous over carbide-comprising surface 12, for example as shown in FIG. 3. Alternately, but less preferred, adherent layer 16 might be discontinuous over carbide-comprising surface 12. For example, FIG. 4 depicts an alternate embodiment substrate fragment 9a having an example discontinuous adherent layer 16a formed over carbide-comprising surface 12. Like numerals from the first-described embodiment have been utilized where appropriate, with differences being indicated with the suffix “a”. Regardless, an example preferred thickness for layers 16/16a are ones that are no greater than 2.0 mm, with from 0.25 mm to 1.0 mm being a specific preferred range.

Referring to FIG. 5, a metal-comprising piece 20 is diagrammatically shown in juxtaposition over substrate 10, and a metal-based joining material 22 has been provided over, and preferably “on” as shown, adherent layer 16. In one implementation, adherent layer 16 has a maximum thickness that is less than that of metal-based joining material 22 at least at this point in the process. Regardless, in one implementation metal-based joining material 22 is no greater than 3.0 mm in thickness at least at this point in the process, and even more preferably is from 1.0 mm to 2.0 mm in thickness. Regardless, in one preferred implementation as shown, metal-based joining material 22 is provided over adherent layer 16 by application over material layer 16. Alternately by way of example only, material 22 might be provided over adherent layer 16 by being applied to metal-comprising piece 20 as opposed to over substrate 10. Further and regardless, application of layer 22 might not necessarily be continuous, but such is preferred and shown. Metal-based joining material 22 can be of any suitable existing or yet to be developed material.

Metal-comprising piece 20 might be homogeneous, non-homogeneous, and/or comprise multiple different materials and/or layers of the same or different materials. An example preferred composition is an alloy sheet, for example a titanium alloy sheet having a thickness range of from ¼″ to 1.5″.

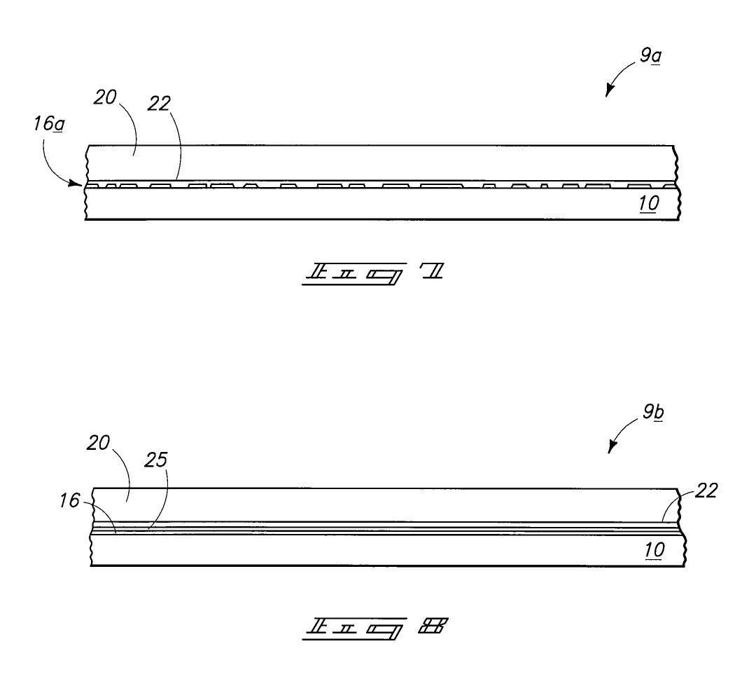

Referring to FIG. 6, metal of metal-comprising piece 20 has been welded to substrate 10 with metal-based joining material 22. In the context of this document, “welding” is a joining process generically encompassing brazing and soldering and, regardless, that produces a unification of materials by heating using a filler material such as the recited metal-based joining material. Brazing is a process of joining materials with a filler material that melts at or above 450° C., while soldering is a process of joining materials with a filler material that melts below 450° C. During such welding, the thickness of one, both, or neither of adherent layer 16 and metal-based joining material 22 might be reduced. Regardless, the welding might be conducted with or without pressure of substrates 20 and 10 against one another, with or without only localized heating, in a furnace, and/or by any other welding method whether existing or yet-to-be developed.

FIG. 7 depicts alternate embodiment substrate fragment 9a having metal-comprising piece 20 welded with substrate 10 using a metal-based joining material 22 received over discontinuous adherent layer 16a.

FIG. 8 depicts an alternate embodiment substrate fragment 9b comprising a layer 25 received intermediate adherent layer 16 and metal-based joining material 22. In one implementation, such comprises an electrolessly-deposited nickel layer provided onto adherent layer 16 prior to welding.

Aspects of the invention also include a method of metallizing a carbon-comprising surface independent of whether a metal-based joining material is provided over an adherent layer, and independent of the above-stated welding. Preferred attributes of a method of metallizing a carbon-comprising surface are otherwise as described above.

Aspects of the invention also contemplate a piece of ceramic armor independent of the method of fabrication, although the above-described methodologies, compositions, and dimensions constitute preferred methods and attributes of forming a piece of ceramic armor in accordance with an aspect of the invention. In accordance with one aspect of the invention, a piece of ceramic armor comprises a sheet of metal, for example a sheet of metal 20 as shown in any of FIGS. 6-7 and having any of the example attributes described above. The piece of ceramic armor comprises a metal-based layer of joining filler material received on the sheet of metal, for example and by way of example only a metal-based layer of joining filler material 22 shown in any of FIGS. 6-8.

The piece of ceramic armor also comprises a layer comprising (a) and (b) over the metal-based joining filler material, where (a) comprises at least one of niobium and titanium, and (b) comprises silicon. In any of the FIGS. 6-8 embodiments, layer 16/16a constitutes an example such layer. A carbide-comprising sheet is received on the layer comprising (a) and (b), with carbide-comprising sheet 10 by way of example only in FIGS. 6-8 constituting an example such sheet of carbide-comprising material. Preferred attributes of the piece of ceramic armor as respects thicknesses and materials of construction are otherwise as described above.

### EXAMPLE 1

Eighty grams of niobium metal and twenty grams of silicon metal were mechanically mixed together using a Turbula tumbling mixer (available from Glenn Mills of Clifton, N.J.). These powders were then spread as a thin layer (i.e., from 0.001 to 0.020 inch thick) on a dense substrate of alpha-phase SiC. The Nb powder was a bi-modal mixture of large and small sizes that were primarily angular in morphology with an average particle size of 9.23 micrometers. The SiC substrate plus the layer of Nb and Si powder were then fired to 1550° C., with a 1-hour hold, using an inert atmosphere (Argon at greater than 99.9% purity).

After firing, the surface of the SiC exhibited what appeared to be a thin layer of gray-colored metallization under a thick layer of unattached powder. The unattached powder was removed via rubbing on a rough bond-type paper. This exposed the gray-colored layer that was well attached (using a scratch test) to the SiC substrate. Microscopic examination also revealed that the gray-colored layer was a metallic layer that was very well bonded to the SiC with smooth features indicative of the presence of a liquid phase. The metallized layer was relatively thin (approximately 10 microns maximum). Microscopic examination revealed that the Nb particles (original average particle size of 9.23 micrometers had been sintered together and that the thin metallic layer was densified. There also was evidence of liquid-phase sintering (rounding of grain structures).

The 80 Nb:20 Si metallized SiC substrate was then brazed to a Ti alloy (Ti-6 wt % Al-4 wt % V). An Al—Si powdered braze plus 30 volume percent beta SiC powder was utilized as a metal-based joining filler mateiral. In particular, a #LTB-42-00 braze (a 90 wt % Al and 10 wt % Si, available from Omni Technologies Corp. of Brentwood N.H.), which melts at 577-591° C., was used with a hold temperature of 650° C. and hold time of 15 minutes. The atmosphere utilized was 3-4 wt percent hydrogen in argon. After cooling, good adhesion strength of 10,000 psi was measured. The estimated yield strength of this braze alloy was a higher value at 25,000 psi. Therefore, it appeared that the measured bond strength was that of adhesion between the metallized layer and the SiC substrate.

### EXAMPLE 2

Ninety grams of niobium metal and ten grams of silicon metal were mechanically mixed together using a Turbula mixer. These powders were then spread as a thin layer on a dense substrate of alpha-phase SiC. The Nb powder was a bi-modal mixture of large and small sizes that were primarily angular in morphology with an average particle size of 9.23 micrometers. The SiC substrate plus the layer of Nb and powder were then fired to 1550° C., with a 1-hour hold, using an inert (Argon UHP grade) atmosphere.

After firing, the surface of the SiC exhibited what appeared to be a thin layer of gray-colored metallization under a thick layer of unattached powder. The unattached powder was removing via rubbing on a rough bond-type paper. This exposed the gray-colored layer that is well attached to the SiC substrate. Microscopic examination revealed that the gray-colored layer was a metallic layer that was very well bonded to the SiC with smooth features indicative of the presence of a liquid phase. The metallized layer was relatively thin (approx. 10 microns maximum), but the coating was not continuous.

The 90 wt % Nb/10 wt % Si metallized SiC substrate was then brazed to a Ti alloy (Ti-6 wt % Al-4 wt % V). An Al—Si powdered braze plus 30 volume percent beta SiC powder was utilized as a metal-based joining filler material. In particular, an Omni Technologies Corp. braze #LTB-35-00 (86 wt % Al/10 wt % Si/4 wt % Cu), which melts at 521-585° C.] was used with a hold temperature of 650° C. and hold time of 15 minutes. The atmosphere utilized was 3-4 wt percent hydrogen in argon. Adhesion strength of 3,000 psi was measured.

### EXAMPLE 3

A mechanical mixture of 95 grams of Ti and 5 grams of Si powders was made using a Turbula mixer. These powders were then spread as a thin layer on a dense substrate of apha-phase SiC. The SiC substrate plus the layer of Ti and Si powder were then fired to 1550° C., with a 1-hour hold, using an inert (Argon UHP grade) atmosphere.

After firing, the surface of the SiC exhibited a thin layer of silver-colored metallization. This metallization layer would not scrape off using a metal tool. Microscopic examination revealed that the layer was very well bonded to the SiC, and was approximately 3-4 microns thick. The grains appeared to be “sintered” together with rounded edges. Some grains were “mud-cracked”. The rounding was likely evidence of the Si liquid phase (likely transient), while the cracking may due to volume shrinkage and/or formation of second phase(s). Electron Dispersive Spectrometry analysis of the coating indicated 98.0 atomic percent Ti and 1.83 atomic percent Si. X-ray diffraction of the coating showed the presence of a small TiC peaks (in addition to SiC). No titanium metal, silicon metal, or titanium silicide phases were detected by the x-ray diffraction. Excess titanium metal (and possibly silicon metal) may have been removed when loose particles were brushed away after the pre-metallization process and prior to scanning electron microscope examination.

A thin “flash” coat of electroless Ni was deposited on the Ti—Si. Such was deposited using a Buehler Edgemet Electroless Specimen coating kit (Buehler Ltd, 41 Waukegan Rd, Lake Bluff Ill., 60044). Equal parts of Solution A (Nickel chloride 45 gm/L, sodium acetate 50 gm/L, sodium citrate 100 gm/L, with the remaining being distilled water) and Solution B (sodium hypophosphite 26.4 gm/L, with the remaining being distilled water) were mixed and heated to an operating temperature of 180-190° F. A coating time of approximately 30 minutes was used. The parts were then washed with distilled water and dried. This resulted in a nickel coating of approximately 0.0003 inch.

The electroless nickel coating (including the underlying pre-metallization and SiC substrate) was then fired to 960° C. in a reducing atmosphere (3-4 weight percent hydrogen in argon) for a hold time of 30 minutes in order to establish a bond between the nickel and the underlying pre-metallization layer.

The metallized-SiC was then joined to a Ti alloy sheet (Ti-6 wt % Al-4 wt % V) using a high-strength solder. The solder used was # 182 (80 wt % Au/20 wt % Sn available from Indium Corporation of Utica, N.Y.) with a melting point of 280° C. and a tensile strength of 40,000 psi. A soldering temperature of 350° C. was used, with a hold time of 15 minutes in a reducing atmosphere (3-4% hydrogen in argon). Bond strength of 9,000 psi was measured.

### EXAMPLE 4

A mechanical mixture of 70 grams of Ti and 30 grams of Si powders was made using a Turbula mixer. These powders were then spread as a thin layer on a dense substrate of apha-phase SiC. The SiC substrate plus the layer of Ti and Si powder was then fired to 1550° C., with a 1-hour hold, using an inert (Argon UHP grade) atmosphere.

After firing, the surface of the SiC exhibited a thin layer of silver-colored metallization. The polished cross-section of the sample showed a coating consisting of unconnected “islands” of metal.

A thin “flash” coat of electroless Ni was deposited on the Ti—Si layer. Such was deposited using a Buehler Edgemet Electroless Specimen coating kit (Buehler Ltd, 41 Waukegan Rd, Lake Bluff Ill., 60044). Equal parts of Solution A (Nickel chloride 45 gm/L, sodium acetate 50 gm/L, sodium citrate 100 gm/L, with the remaining being distilled water) and Solution B (sodium hypophosphite 26.4 gm/L, with the remaining being distilled water) were mixed and heated to an operating temperature of 180-190° F. A coating time of approximately 30 minutes was used. The parts were then washed with distilled water and dried. This resulted in a nickel coating of approximately 0.0003″.

The electroless nickel coating (including the underlying pre-metallization and SiC substrate) was then fired to 960° C. in a reducing atmosphere (3-4 wt percent hydrogen in argon) for a hold time of 30 minutes to establish a bond between the nickel and the underlying pre-metallization layer.

The metallized SiC was then joined to a Ti alloy (Ti-6 wt % Al-4 wt % V) using a high-strength solder. The solder used was Indium Corporation #182 (80 wt % Au 20 wt % Sn) with a melting point of 280° C. and a tensile strength of 40,000 psi. A soldering temperature of 350° C. was used with a hold time of 15 minutes in a reducing atmosphere (3-4 wt % hydrogen in argon). A bond strength of 1,800 psi was obtained.

### EXAMPLE 5

Powdered metals were mixed in a Turbula mixer. The formula was 40 wt % Zr, 30 wt % Si, 18 wt % Ti, 10 wt % Cu, 1 wt % In. After mixing these powders, such were sprinkled onto a top surface of a dense alpha phase SiC cylinder (SiC material fabricated at Superior Graphite Co. of Chicago, Ill.) until the surface was covered. The part was then heated to 1450° C. (1.0 hour hold) under a 4 wt % H2 in Ar atmosphere. A very thin, well adhered, metallization layer resulted on the SiC. Microscopic examination revealed this layer to be 7-10 microns thick.

The metallized SiC was then joined to a Ti alloy (Ti-6 wt % Al-4 wt % V) using a brazing alloy with a low thermal coefficient of expansion fillers. In particular, type 721 powdered braze was utilized (HF 410/40-020/80D1, available from Lucas-Mllhaupt Inc. of Cudahy, Wis.). Such is an Ag—Cu—Ti (72.0 wt % Ag, 28.0 wt % Cu) braze in a proprietary organic carrier making a paste. Specification for Ti content is 8-10 wt %. The liquidus temperature of the type 721 is 780° C., with a normal brazing range of 790-950° C. A temperature of 880° C. was used in an inert (4 wt % hydrogen in argon) atmosphere with a hold time of 20 minutes. Thirty volume percent beta SiC powder was used as a “filler” to lower the thermal expansion of the joint.

After brazing, 12,000 psi adhesion strength was measured.

### EXAMPLE 6

Powdered metals were mixed in a Turbula mixer. The formula was 40 wt % Zr, 30 wt % Si, 18 wt % Ti, 10 wt % Cu, 1 wt % In). After mixing these powders, such were sprinkled onto a top surface of a dense alpha phase SiC cylinder (SiC material fabricated at Superior Graphite Co.) until the surface was covered. The part was then heated to 1450° C. (1.0 hour hold) under a 4 wt % H2 in Ar atmosphere. A very thin, well adhered, metallization layer resulted on the SiC. Microscopic examination revealed this layer to be 7-10 micron thick.

A thin “flash” coat of electroless Ni was deposited on the Ti—Si premetallization layer. Such electroless nickel was deposited using a Buehler Edgemet Electroless Specimen coating kit (Buehler Ltd, 41 Waukegan Rd, Lake Bluff Ill., 60044). Equal parts of Solution A (Nickel chloride 45 gm/L, sodium acetate 50 gm/L, sodium citrate 100 gm/L, with the remaining being distilled water) and Solution B (sodium hypophosphite 26.4 gm/L, with the remaining being distilled water) were mixed and heated to an operating temperature of 180-190° F. A coating time of approximately 30 minutes was used. The parts were then washed with distilled water and dried. This resulted in a nickel coating of approximately 0.0003″.

The electroless nickel coating (including the underlying pre-metallization and SiC substrate) was then fired to 960° C. in a reducing atmosphere (3-4 wt % hydrogen in argon) for a hold time of 30 minutes in order to establish a bond between the nickel and the underlying pre-metallization layer.

The metallized SiC was then joined to a Ti alloy (Ti-6 wt % Al-4 wt % V) using a high-strength solder. The solder used was #209 (55 wt % Sn, 25 wt % Ag, 20 wt % Sb) having a melting point of 233° C. and a tensile strength of 17,000 psi. A soldering temperature of 350° C. was used with a hold time of 15 minutes in a reducing atmosphere (3-4 wt % hydrogen in argon). A bond strength of 9,000 psi was obtained.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

The invention claimed is:

1. A method of joining a carbide with a metal-comprising piece, comprising:
providing a mixture comprising (a) and (b) over a carbide-comprising surface of a substrate, where (a) comprises at least one of niobium and titanium, and (b) comprises silicon;
heating the mixture over the carbide-comprising surface at least to the melting temperatures of (a) and (b);
solidifying the melted mixture into an adherent layer on the substrate;
providing a metal-based joining material over the adherent layer; and
welding metal of a metal-comprising piece to the substrate with the metal-based joining material.

2. The method of claim 1 wherein the heating is at least to the melting temperatures of all components of the mixture.

3. The method of claim 1 wherein (a) comprises niobium.

4. The method of claim 3 wherein the adherent layer consists essentially of niobium and silicon at least prior to said welding.

5. The method of claim 4 wherein weight ratio of niobium to silicon in the mixture is about 4:1.

6. The method of claim 1 wherein (a) comprises titanium.

7. The method of claim 3 wherein the adherent layer consists essentially of titanium and silicon at least prior to said welding.

8. The method of claim 1 wherein (a) comprises both of niobium and titanium.

9. The method of claim 1 wherein weight ratio of a total of the at least one of niobium and titanium to silicon in the mixture is from 1:1 to 11:1.

10. The method of claim 9 wherein weight ratio of a total of the at least one of niobium and titanium to silicon in the mixture is from 2.3:1 to 9:1.

11. The method of claim 1 wherein the (a) comprises titanium, and the mixture comprises zirconium, titanium, copper, and silicon.

12. The method of claim 11 wherein in a total of the zirconium, titanium, copper, and silicon in the mixture, zirconium is from 30-40 weight percent, silicon is from 20-40 weight percent, titanium is from 13-23 weight percent, and copper is from 7-13 weight percent.

13. The method of claim 11 wherein the mixture comprises indium.

14. The method of claim 13 wherein in a total of the zirconium, titanium, copper, indium, and silicon in the mixture, zirconium is from 30-40 weight percent, silicon is from 20-40 weight percent, titanium is from 13-23 weight percent, copper is from 7-13 weight percent, and indium is no greater than 2 weight percent.

15. The method of claim 1 wherein the adherent layer is continuous over the carbide-comprising surface.

16. The method of claim 1 wherein the adherent layer is discontinuous over the carbide-comprising surface.

17. The method of claim 1 wherein the mixture is provided on the carbide-comprising surface.

18. The method of claim 1 wherein the carbide-comprising surface comprises at least one of silicon carbide, boron carbide, titanium carbide, and mixtures thereof.

19. The method of claim 1 wherein the heating comprises raising temperature of the substrate to from 1450° C. to 1550° C.

20. The method of claim 1 wherein the heating occurs within a subatmospheric atmosphere.

21. The method of claim 20 wherein the atmosphere is at a pressure of no greater than 1 Torr.

22. The method of claim 20 wherein the atmosphere is at a pressure of no greater than 1 mTorr.

23. The method of claim 1 wherein the heating occurs within an atmosphere that is substantially void of O₂.

24. The method of claim 23 wherein the atmosphere predominately comprises a noble gas.

25. The method of claim 24 wherein the atmosphere comprises H₂ at no more than 4.0% atomic.

26. The method of claim 1 wherein the adherent layer is no greater than 2.0 mm in thickness at least prior to the welding.

27. The method of claim 26 wherein the adherent layer is from 0.25 mm-1.0 mm in thickness at least prior to the welding.

28. The method of claim 1 wherein the adherent layer has a maximum thickness that is less than that of the metal-based joining material at least prior to the welding.

29. The method of claim 1 wherein the metal-based joining material is no greater than 3.0 mm in thickness at least prior to the welding.

30. The method of claim 29 wherein the metal-based joining material is from 1.0 mm -2.0 mm in thickness at least prior to the welding.

31. The method of claim 1 wherein at least prior to the welding, the adherent layer is from 0.25 mm-1.0 mm in thickness, the metal-based joining material is from 1.0 mm-2.0 mm in thickness, and the adherent layer has a maximum thickness that is less than that of the metal-based joining material.

32. The method of claim 1 comprising providing a metal layer intermediate the adherent layer and the metal-based joining material.

33. The method of claim 1 comprising providing an electrolessly deposited nickel layer intermediate the adherent layer and the metal-based joining material.

34. The method of claim 1 wherein the welding comprises brazing.

35. The method of claim 1 wherein the welding comprises soldering.

36. The method of claim 1 wherein the metal of the metal-comprising piece comprises a titanium alloy.

37. The method of claim 1 wherein the carbide-comprising surface comprises silicon carbide and the metal of the metal-comprising piece comprises an alloy predominately comprising titanium.

38. The method of claim 1 comprising reducing thickness of the metal-based joining material during the welding.

39. A method of joining a carbide with a metal-comprising sheet, comprising:
providing a mixture comprising (a) and (b) over a carbide-comprising surface of a substrate, where (a) comprises at least one of niobium and titanium, and (b) comprises silicon; the carbide-comprising surface comprising at least one of silicon carbide, boron carbide, titanium carbide, and mixtures thereof; weight ratio of a total of the at least one of niobium and titanium to silicon in the mixture being from 1:1 to 11:1;
heating the mixture over the carbide-comprising surface at least to the melting temperatures of all components of the mixture in an atmosphere that is substantially void of O₂;
solidifying the melted mixture into an adherent layer on the substrate having a thickness that is no greater than 2.0 mm;
providing a metal-based joining material over the adherent layer to a thickness of no greater than 3.0 mm; and
welding metal of a metal-comprising sheet to the substrate with the metal-based joining material.

40. The method of claim 39 wherein the carbide-comprising surface is of a mass of carbide-material that has a thickness of from 0.25 inch to 1.0 inch, and the metal-comprising sheet is of a thickness of no greater than 1.5 inches.

41. The method of claim 39 wherein the adherent layer is from 0.25 mm-1.0 mm in thickness at least prior to the welding.

42. The method of claim 39 wherein the adherent layer has a maximum thickness that is less than that of the metal-based joining material at least prior to the welding.

43. The method of claim 39 wherein the metal-based joining material is from 1.0 mm-2.0 mm in thickness at least prior to the welding.

44. The method of claim 39 wherein at least prior to the welding, the adherent layer is from 0.25 mm-1.0 mm in thickness, the metal-based joining material is from 1.0 mm-2.0 mm in thickness, and the adherent layer has a maximum thickness that is less than that of the metal-based joining material.

45. A method of metallizing a carbide-comprising surface, comprising:
providing a substrate having a carbide-comprising surface;
providing a mixture comprising (a) and (b) over the carbide-comprising surface, where (a) comprises at least one of niobium and titanium, and (b) comprises silicon;
heating the mixture over the carbide-comprising surface at least to the melting temperatures of (a) and (b); and
solidifying the melted mixture into an adherent layer on the carbide-comprising surface.

46. The method of claim 45 wherein the heating is at least to the melting temperatures of all components of the mixture.

47. The method of claim 45 wherein the mixture is provided on the carbide-comprising surface.

48. The method of claim 45 wherein the carbide-comprising surface comprises at least one of silicon carbide, boron carbide, titanium carbide, and mixtures thereof.

49. A piece of ceramic armor comprising:
a sheet of metal;
a metal-based layer of joining filler material on the sheet of metal;
a layer comprising (a) and (b) over the metal-based joining filler material layer, where (a) comprises at least one of niobium and titanium, and (b) comprises silicon; and
a sheet of carbide-comprising material on the layer comprising (a) and (b).

50. The piece of ceramic armor of claim 49 wherein the layer comprising (a) and (b) is received on the metal-based layer of joining filler material.

51. The piece of ceramic armor of claim 49 wherein the layer comprising (a) and (b) is not received on the metal-based layer of joining filler material.

52. The piece of ceramic armor of claim 49 comprising a layer of nickel on the layer comprising (a) and (b), the metal-based layer of joining filler material being received on the layer of nickel.

53. The piece of ceramic armor of claim 49 wherein the layer comprising (a) and (b) is continuous.

54. The piece of ceramic armor of claim 49 wherein the layer comprising (a) and (b) is discontinuous.

55. The piece of ceramic armor of claim 49 wherein the sheet of metal comprises a titanium alloy.

56. The piece of ceramic armor of claim 55 wherein the sheet of metal comprises an alloy that predominately comprises titanium, and the carbide comprises silicon carbide.

57. The piece of ceramic armor of claim 49 wherein the layer comprising (a) and (b) has a weight ratio of a total of the at least one of niobium and titanium to silicon at from 1:1 to 11:1.

58. The piece of ceramic armor of claim 49 wherein the layer comprising (a) and (b) is of a thickness no greater than 2.0 mm.

59. The piece of ceramic armor of claim 58 wherein the layer comprising (a) and (b) is of a thickness from 0.25 mm to 1.0 mm.

60. The piece of ceramic armor of claim 49 wherein the layer comprising the metal-based joining filler material is of a thickness no greater than 3.0 mm.

61. The piece of ceramic armor of claim 60 wherein the layer comprising the metal-based joining filler material is of a thickness from 0.5 mm to 2.0 mm.

62. The piece of ceramic armor of claim 49 wherein the layer comprising (a) and (b) has a thickness that is less than that of the metal-based joining filler material layer.

63. The piece of ceramic armor of claim 62 wherein the layer comprising (a) and (b) is of a thickness from 0.25 mm to 1.0 mm, and the metal-based joining filler material layer is of a thickness from 0.5 mm to 2.0 mm.

64. The piece of ceramic armor of claim 49 wherein the sheet of metal is no greater than 1.5 inches thick, and the carbide-comprising sheet is no greater than 1.0 inches thick.

65. The piece of ceramic armor of claim 49 wherein (a) comprises niobium.

66. The piece of ceramic armor of claim 65 wherein the layer comprising (a) and (b) consists essentially of niobium and silicon.

67. The piece of ceramic armor of claim 49 wherein (a) comprises titanium.

68. The piece of ceramic armor of claim 67 wherein the layer comprising (a) and (b) consists essentially of titanium and silicon.

69. The piece of ceramic armor of claim 49 wherein (a) comprises both of niobium and titanium.

70. The piece of ceramic armor of claim 49 wherein the layer comprising (a) and (b) comprises zirconium, titanium, copper, and silicon.

71. The piece of ceramic armor of claim 70 wherein in a total of the zirconium, titanium, copper, and silicon in the layer comprising (a) and (b), zirconium is from 30-40 weight percent, silicon is from 20-40 weight percent, titanium is from 13-23 weight percent, and copper is from 7-13 weight percent.

72. The piece of ceramic armor of claim 70 wherein the layer comprising (a) and (b) comprises indium.

73. The piece of ceramic armor of claim 72 wherein in a total of the zirconium, titanium, copper, indium, and silicon in the layer comprising (a) and (b), zirconium is from 30-40 weight percent, silicon is from 20-40 weight percent, titanium is from 13-23 weight percent, copper is from 7-13 weight percent, and indium is no greater than 2 weight percent.
